(19) United States
(12) Patent Application Publication
(10) Pub. No.: US 2018/0334202 A1
(43) Pub. Date: Nov. 22, 2018

(54) "Trucker Tool" Multipurpose

(71) Applicants: Allan Lee Broussard, Sherwood, AR (US); Don William Broussard, Ward, AR (US)

(72) Inventors: Allan Lee Broussard, Sherwood, AR (US); Don William Broussard, Ward, AR (US)

(21) Appl. No.: 15/819,060

(22) Filed: Nov. 21, 2017

Related U.S. Application Data
(60) Provisional application No. 62/603,089, filed on May 17, 2017.

(51) Int. Cl. B62D 53/08; B66F 15/00

(52) U.S. Cl. CPC B62D 53/0857; B66F 15/00

(57) ABSTRACT

The “Trucker's Tool” is a safer way to pull fifth wheel handles because the length allows truck drivers to stand up straight with (both) feet flat on the ground when pulling on the fifth wheel handle. The “Trucker's Tool” keeps you from bending your back and reaching over the top of the tires to pull the fifth wheel handle with your hand, putting you in an unsafe position. Standing up straight when pulling on the fifth wheel handle helps to keep a driver's head, hand, wrist, arm, and shoulder away from dangerous areas. A driver can put (both) hands on the “Trucker's Tool” when pulling the fifth wheel handle, allowing them to use twice the strength and less the strain on the above mentioned areas of the body helping to lower the risk of injury.

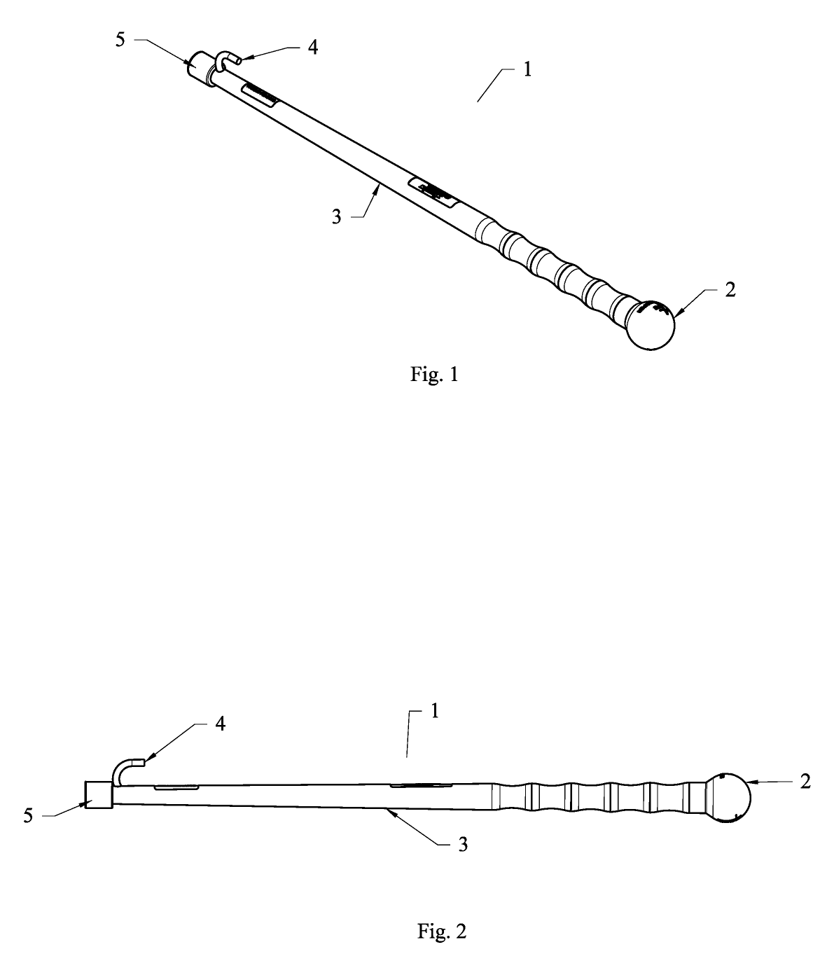

(FIG. 1)

Invention

(FIG. 2)

Depicts horizontal view of FIG. 1

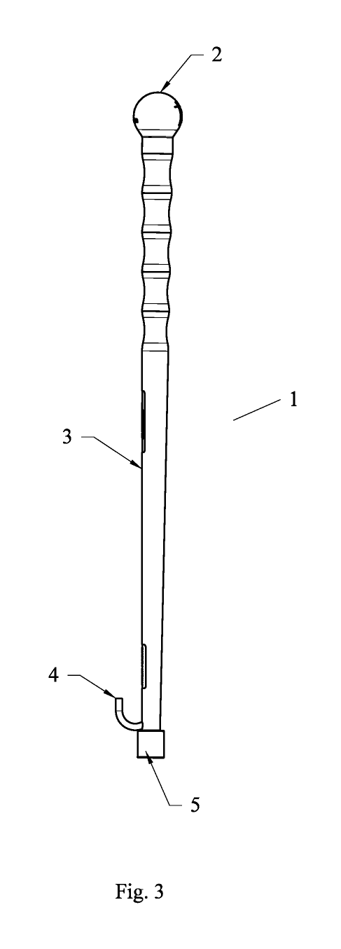

(FIG. 3)

Vertical view of FIG. 1

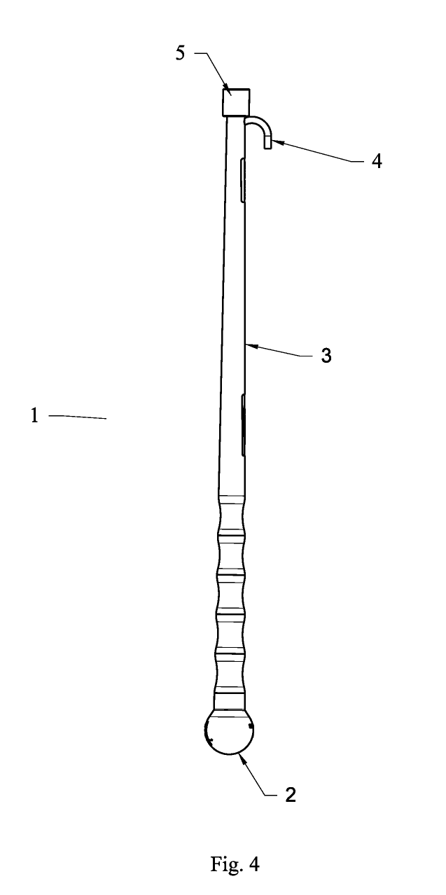

(FIG. 4)

Vertical view of FIG. 3 rotated 180 degrees

The below numbers, 1-5, correspond to the numbers on each above figure.

1. Invention

2. The handgrip/weighted tire thumper.

3. Below the tire thumper is the shaft of the invention, an extension of the fifth wheel puller and used as a support in connecting the tools on one embodiment.

4. The fifth wheel puller hook is located near the end of the shaft of the invention. The hook is part of a steel rod embodied inside the shaft of the invention.

5. Rubber tip is below the hook at the bottom of invention.

### DESCRIPTION OF INVENTION

It's called a “Trucker's Tool” multi-purpose because you have on one embodiment the following tools all connected.

A hand sized grip at the top for pulling on the fifth wheel handle or walking. The hand grip is also weighted so it is used as a tire thumper allowing drivers to check for low air or flats.

The shaft is used as an extension of the fifth wheel puller, and for walking or support when getting under a trailer for viewing locking jaws around the king pin of the fifth wheel.

The fifth wheel puller is a steel rod embodied in the shaft of the invention and coming out of the shaft as a hook for pulling the fifth wheel handle. The replaceable push on/pull off rubber walking tip is at the end of the invention below the fifth wheel puller, allowing the tip to better grip the ground surface when using the invention as a support or walking assistant.

All of the above on (1) embodiment allows the tools to be carried connected to each other.

1. A one embodiment multi truckers tool apparatus comprising of:
a molded stick;
a weighted ball member molded to said molded stick as one embodiment;
and a steel rod member molded inside of said molded stick;
and a visible hook member of said steel rod and said molded stick;
and a rubber tip member removably secured to said molded stick.

2. The apparatus of claim 1, the said molded stick comprising a handgrip for walking and support.

3. The apparatus of claim 1, the molded one embodiment said stick further comprising a said weighted ball member for tire thumping.

4. The apparatus of claim 1, further comprising a steel rod member with visible hook for pulling a truck's fifth wheel handle.

5. The apparatus of claim 1, further comprising a removably secured rubber tip for gripping the ground surface.
